(19) United States
(12) Patent Application Publication
(10) Pub. No.: US 2026/0289837 A1
(43) Pub. Date: Sep. 24, 2026

(54) Online Football Simulation Playbook

(71) Applicant: Lark Collin, Dallas, TX (US)

(72) Inventor: Collin Lark, Dallas, TX (US)

(21) Appl. No.: 19/085,344

(22) Filed: Mar. 20, 2025

(51) Int. Cl. G06T 11/20; A63B 69/00; G06F 40/211

(52) U.S. Cl. CPC G06T 11/26; A63B 69/002; G06F 40/211

(57) ABSTRACT

The present invention relates to a system and method for creating, organizing, and visualizing football plays using a syntax-driven approach. The system provides a modular play creation platform where predefined components of football plays, including formations, motions, routes, and pass concepts, are combined using a structured syntax. User inputs are parsed and rendered into dynamic 2D visualizations, allowing coaches and players to conceptualize plays intuitively. The system includes a digital whiteboard interface for real-time play creation and collaboration, as well as a mobile application for assigning plays to players for independent practice. Unlike traditional playbooks or systems reliant on real-time telemetry, the invention is focused on static visualization and does not depend on sensor-based data or motion tracking. The method enhances the efficiency of play creation and learning, making it a cost-effective and scalable solution for football teams at all levels. The invention further includes features such as syntax validation, cloud-based storage, and replay functionality, providing a comprehensive tool for football strategy development and player education.

### CROSS-REFERENCE TO RELATED APPLICATIONS

None.

### TECHNICAL FIELD

The present invention relates to systems and methods for creating, organizing, and visualizing football plays, specifically employing a syntax-driven approach to streamline playbook development, enhance player learning, and improve strategic collaboration between coaches and players, utilizing modular, non-sensor-based visualization technology in a 2D environment.

PRIOR ART REFERENCES

| | | |
|---|---|---|
| U.S. Pat. No. 10,441,686 B2 | Brian Jansen | Oct. 15, 2019 |
| Full Scale Digital Replay and Practice System | | |
| for Use By Positional Players in a Team-Based | | |
| Sport | | |
| U.S. Pat. No. 11,173,376 B2 | Brian Janssen | Nov. 16, 2021 |
| FULL SCALE PRACTICE, TRAINING AND | | |
| DIAGNOSTIC SYSTEM METHOD AND | | |
| SOFTWARE MEDIUM . . . | | |
| U.S. Pat. No. 9,364,747 B2 | Charles Meyer, Dean Dalton, | Jun. 14, 2016 |
| 3D Sports Playbook | Scott Gaff, Christpoher | |
| | Ebbert | |

### DESCRIPTION OF PRIOR ART

Football coaching and play design have historically relied on static playbooks, whether in paper or digital formats, to communicate strategies to players. These playbooks often include diagrams and written descriptions but lack interactivity and adaptability. Over time, software solutions like Quick Pro Draw, TeamNation, and Learn to Win emerged, offering limited digital enhancements such as drag-and-drop play creation and static visual representations.

However, these platforms fall short in providing a syntax-driven approach to play creation. They often rely on manually dragging elements or inputting data into predefined templates, which can be time-consuming and restrictive. Additionally, many existing systems incorporate real-time data tracking or simulations, requiring costly hardware such as motion sensors or field telemetry systems, making them impractical for many teams.

The evolution of football playbooks has increasingly focused on leveraging technology to enhance player learning and retention. Yet, current solutions either prioritize athlete performance tracking or static play visualization without addressing the need for a dynamic, intuitive, and cost-effective system for creating and teaching plays. Furthermore, the reliance on traditional methods of conveying plays limits player engagement and learning opportunities outside of practice.

The invention of FootballU represents a breakthrough in this field, introducing a structured syntax-to-visualization methodology that is unprecedented in football playbook technology. Unlike traditional playbook solutions, FootballU allows coaches and players to collaboratively design and practice plays in an interactive, syntax-driven format. The platform eliminates the need for manual play diagramming and provides a mobile-friendly interface for players to learn and practice plays on their own time.

By focusing on static, structured visualization rather than real-time simulations or player tracking, FootballU offers a scalable and accessible solution for teams at all levels, from amateur leagues to professional organizations. This unique approach not only modernizes the way playbooks are created but also revolutionizes the teaching and learning process for football strategies.

### SUMMARY OF THE INVENTION

The present invention pertains to a syntax-driven methodology for creating, organizing, and visualizing football plays in a 2D environment. Unlike conventional digital or static playbooks, which rely on diagrams or real-time data inputs, the invention focuses on a structured play-call syntax that enables dynamic play creation and visualization. The system is implemented through a software platform called FootballU, offering innovative tools to revolutionize the way football teams conceptualize, design, and teach plays.

The unique feature of the invention lies in its modular approach to playbook creation, where each component of a football play—such as formations, motions, routes, and pass concepts—is individually defined and synthesized into a complete play using a predefined syntax. This modularity allows users to intuitively construct plays by typing commands, which are then automatically visualized on a 2D virtual field. Key aspects of the invention include:

Syntax-Driven Play Construction: A structured play-call syntax enables users to create plays by specifying commands such as formations, motions, and pass concepts. These inputs are instantly rendered as visualized plays on a 2D screen, providing immediate feedback and clarity.

Whiteboard Integration: The system incorporates a digital whiteboard feature, allowing users to type commands that are automatically translated into dynamic play diagrams. This eliminates the need for manual diagramming, enhancing the efficiency of playbook creation.

Play Replication and Learning Module: The invention includes a “Rep” feature, which allows coaches to assign specific plays to players via a mobile app. Players can review and practice these plays independently, improving retention and understanding outside of traditional practice sessions.

Non-Sensor-Based Visualization: The invention operates independently of real-time telemetry, motion tracking, or field-based data collection. It focuses on predefined play visualization, avoiding the complexities and costs associated with sensor-based systems.

Coach-Player Collaboration: The platform facilitates better communication between coaches and players by providing a centralized, interactive, and portable solution for playbook dissemination and learning.

Static Visualization over Dynamic Simulations: FootballU emphasizes the structured organization and visualization of plays in a static, 2D environment rather than relying on real-time data or complex 3D simulations. This approach makes the system accessible and adaptable for teams at all levels.

This invention offers a significant advancement in football playbook technology, addressing the shortcomings of traditional methods (e.g., static paper playbooks or digital PDFs) while avoiding reliance on expensive and technically demanding real-time data systems.

An example technique begins by receiving input to display a play from a syntax-driven playbook system. For instance, input can be received when a user selects a play from a categorized list of options in the 2D interface pane. The play and its associated data, such as formations, player assignments, routes, and pass concepts, are retrieved from the system's syntax-based data repository.

Upon retrieval, the system dynamically renders the play using the structured syntax in a 2D interface. Each element of the play—formations, motions, routes, and other attributes—is visualized in real-time based on the syntax inputs. For example, selecting a play called “Strong Left 90 Slant” causes the system to parse the syntax into its components: formation (e.g., “Strong Left”), pass concept (e.g., “90 Slant”), and route details for each player. These components are rendered instantly in the 2D interface for review. By way of example, the offensive playbook syntax would include dropdown elements for Shift/Motion/Variation, Formation, Variation/Motion, Play Call, Pass Concept (strong), Pass Concept (weak), and Skill Player Tags. The offensive and defensive syntax can be customized for a team's playbook, creating a unique play syntax.

The interface allows users to modify plays through syntax inputs. For example, users can input commands to adjust player positions, routes, or timing directly within the system. Each player is represented as an object with attributes such as position, role, speed, and movement direction. When a user modifies syntax—such as specifying a route adjustment for a receiver or changing a formation—the system dynamically updates the 2D visualization to reflect these changes. For instance, a syntax input that adjusts a wide receiver's route to include a sharper cut or earlier break will immediately update the player's visualized path in the 2D environment.

The system also accounts for player attributes and route-specific characteristics in the visualization. Player attributes include variables such as size, speed, skill level, and stamina, while route attributes include timing, speed variations along the route, and positional adjustments. For example, the system can simulate how a player's speed affects the timing of a route, providing immediate feedback within the 2D visualization. Movement along the routes is adjusted to reflect these attributes, ensuring an accurate representation of play execution.

In one embodiment, the invention incorporates multiple dropdown selections—Shift/Motion/Variation, Formation, Motion/Variation, Play Call, Pass Concept, and Tags—that collectively define each aspect of a football play within a structured, syntax-driven framework. The “Shift/Motion/Variation” dropdown allows the user to specify a Shift (i.e., a pre-formation alignment), a Motion (i.e., moving a single player pre-snap), or a Formation Variation (i.e., adjusting specific player alignments within the chosen formation). The “Formation” dropdown establishes baseline coordinates for every player relative to the center, ensuring consistency and clarity in initial alignments. A subsequent “Motion/Variation” dropdown provides additional customization, enabling further pre-snap movements or refined alignment tweaks. The “Play Call” component then dictates post-snap responsibilities or alignment adjustments for individual players, while the “Pass Concept” categories assign broader route structures—such as slants or flats—to receivers on either side of the formation. Finally, “Tags” offer a granular means to append individualized route instructions for specific players, facilitating targeted modifications at the end of a call. By organizing each aspect of a play through these modular dropdowns, the system dynamically renders a comprehensive 2D visualization in real time, aligning with the invention's goal of delivering a syntax-based, cost-effective, and accessible solution for football play design, review, and collaboration.

The FootballU system includes three primary modes, each designed to enhance various aspects of football training and gameplay: Creation Mode, Play Mode, and Digital Rep Mode.

Creation Mode: Creation Mode is exclusively accessible to coach accounts. This mode empowers coaches to create and customize all aspects of a play sentence, allowing them to design, edit, and save plays directly into their playbooks for future use. Coaches have complete flexibility to develop tailored strategies to meet their team's needs.

Play Mode: Play Mode is accessible to both coach and player accounts. This mode enables teams to visualize gameplay, with all players on offense and defense executing their respective plays in a dynamic, interactive environment. A control bar displaying the Offensive and Defensive Sentences is featured at the top and bottom of the Play Mode interface, facilitating real-time adjustments and strategic planning during gameplay.

Digital Rep Mode: Digital Rep Mode is also available to both coach and player accounts. In this mode, individual players can access the FootballU website or app to practice game-like scenarios. This feature allows players to engage with a 2D graphical interface, enabling them to simulate and refine their movements by dragging graphical elements on the screen, thereby enhancing their understanding and execution of plays in a realistic yet controlled environment.

Additionally, variability can be introduced to simulate real-world performance deviations. For instance, the system can modify a receiver's cut timing or the depth of a route to reflect potential scenarios during gameplay. This feature allows users to explore variations in play execution and adapt strategies accordingly. For example, variability might simulate a defender forcing a receiver to cut earlier than expected, providing valuable insights into the robustness of the play design.

Input can also be received to create new plays using syntax-based dropdown menus or free-form command inputs. The interface organizes these options into predefined categories such as formation, play call, pass concept, and route attributes. Users can combine these components dynamically to construct a play, which is then visualized immediately in the 2D environment. For example, selecting options for “Formation: Trips Right,” “Play Call: Flood,” and “Route: Slant” generates a play visualization with synchronized movements for all players.

The system operates independently of real-time telemetry or motion tracking, focusing instead on structured, predefined inputs and visualizations. This architecture ensures cost-effective accessibility while maintaining high flexibility and scalability for teams at all levels. Coaches can save plays in a central repository, assign them to players for independent review, and track engagement via the mobile application.

By leveraging a syntax-driven methodology, this technique revolutionizes play creation and teaching, offering dynamic visualization and unparalleled efficiency compared to traditional methods. The system's ability to adapt plays based on player-specific attributes, route details, and simulated variability enhances strategy development and player understanding.

In one embodiment, the invention is a computer-implemented method that transforms the creation, visualization, and distribution of sports plays through a syntax-driven methodology designed to enhance efficiency, flexibility, and accessibility. This innovative system allows users to define plays using structured syntax, specifying components such as formations, motions, and routes with precision and modularity, enabling rapid and consistent play creation. The graphical user interface dynamically translates these inputs into interactive 2D visualizations, featuring intuitive player icons, adjustable route attributes, and clear feedback to support iterative design.

Users can further refine plays by modifying player positions, routes, or timing through direct interaction or syntax commands, with real-time synchronization ensuring all updates are accurately reflected. Additionally, a mobile application distributes these plays to players, offering interactive playback, annotations, and personalized learning tools that promote independent practice and better retention.

In another embodiment, the syntax-driven play creation module is further configured to define all player alignments relative to a central reference point on the field. This embodiment comprises a positional reference system that calculates each player's X-coordinate as a function of the center's location. Specifically, the system incorporates a coordinate computation engine that receives the current center position and determines the X-coordinate for each player by applying a predefined mathematical offset relative to this central location. In addition, a flexible alignment logic is provided to dynamically adjust the player coordinates when the center is repositioned between predetermined landmarks, such as the hashes. This flexible alignment logic utilizes stored coordinate parameters and real-time mathematical transformations to re-map the players' positions, thereby maintaining consistent relative positioning regardless of shifts in the center's location. The dynamic adjustment ensures that the visual representation of the play remains accurate and proportionally consistent, even as the reference point moves across different field segments.

In another embodiment, the syntax-driven play creation module further comprises a predefined sequence-based syntax for constructing a football play. This syntax establishes a structured order of play components by organizing input commands into a hierarchical sequence that includes, in one example, pre-snap adjustments (such as shifts or motions), selection of formations, subsequent play calls, and optional modifiers (including tags and pass concepts). To enforce this structured order, a dedicated parsing system is employed which validates and organizes the user-supplied commands according to the predetermined sequence. The parsing system ensures a consistent, hierarchical arrangement of these elements, thereby enhancing clarity in the play's design and ensuring compatibility with the subsequent visual rendering processes. By checking the syntax for completeness and conformity to the expected order, the parsing system not only prevents input errors but also facilitates improved recall and a more intuitive user experience in the creation of football plays. The incorporation of this structured syntax and parsing mechanism enables both novice and experienced users to generate and modify play designs with precision and efficiency.

The details of one or more embodiments are set forth in the accompanying drawings and the description herein. Various advantages can be provided by the disclosed techniques, systems, computer program products, and methods. For example, coaches can receive an accurate representation in 2D space of how a play will progress, specifically with regard to the vantage point of various players running the play. Players can more readily visualize their own actions for a play as well as the actions of other players on the field.

Other features, objects, and advantages of the invention will be apparent from the description, drawings, and claims.

### OBJECTS OF THE INVENTION

Enhance Efficiency in Playbook Creation: To provide a syntax-driven methodology that streamlines the creation of football playbooks by allowing users to define and organize plays through predefined modular components, reducing the time and effort required compared to traditional manual or static digital methods.

Improve Play Visualization: To offer a system that dynamically translates structured syntax inputs into 2D visualizations of football plays, enabling coaches and players to conceptualize and understand strategies with greater clarity and precision.

Facilitate Independent Player Learning: To enable players to independently study and practice assigned plays through a mobile application, promoting better understanding and retention of play strategies outside of scheduled practice sessions.

Reduce Dependency on Sensors or Real-Time Data: To provide a system for football play creation and visualization that operates independently of real-time telemetry, motion tracking, or sensor-based inputs, making it a cost-effective and accessible solution for teams at all levels.

Promote Collaboration Between Coaches and Players: To offer a centralized platform that fosters effective communication and collaboration between coaches and players, featuring tools such as a digital whiteboard and interactive play assignments, ensuring alignment and efficiency in strategy dissemination.

### BRIEF DESCRIPTION OF THE DRAWINGS

FIG. 1: A field of play with all play call parameters and routes chosen.

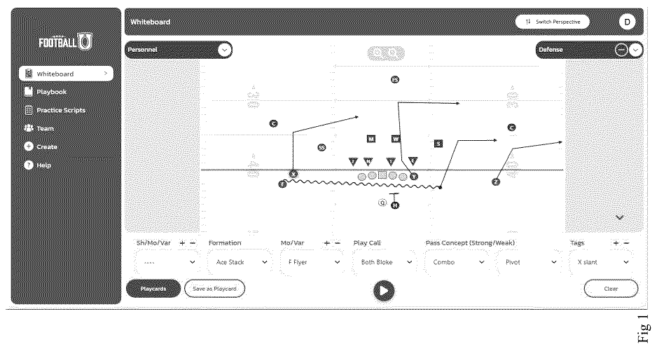

FIG. 2: A field of play with all play call parameters and routes chosen.

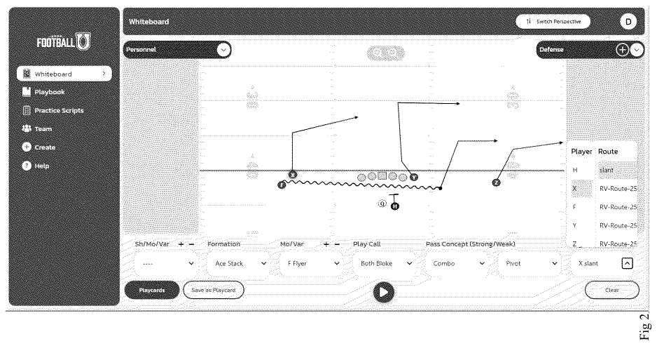

FIG. 3: Describes the basic syntax before any play call parameter is chosen.

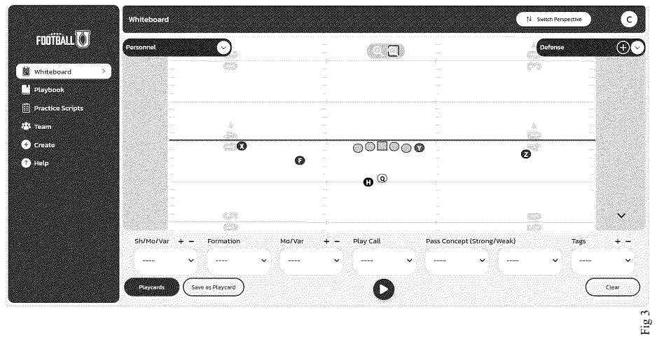

FIG. 4—Formation is chosen.

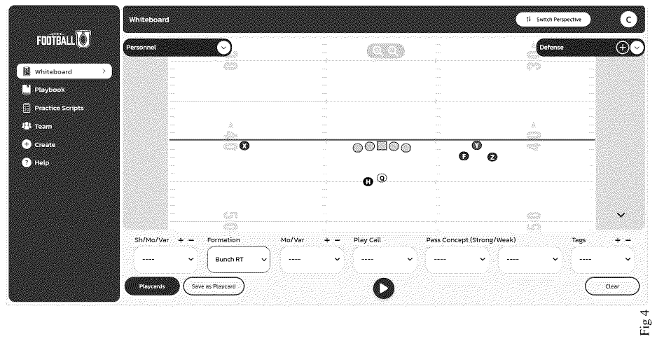

FIG. 5—Formation variation is chosen (applies to the “x” to tighten his split).

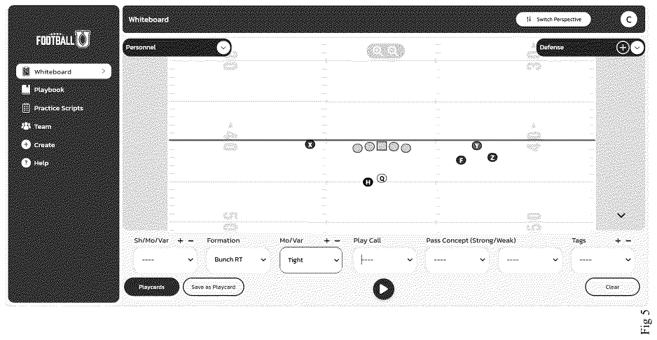

FIG. 6—Presnap motion is chosen.

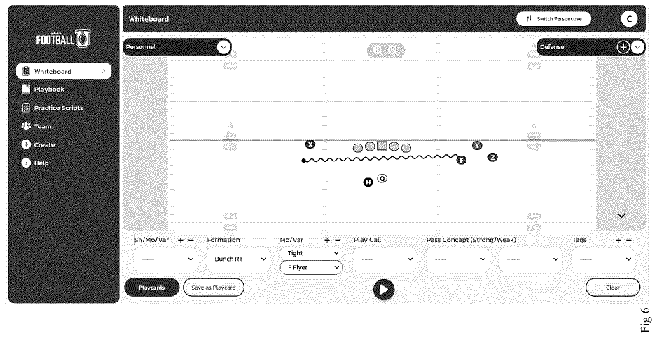

FIG. 7—Playcall is chosen (applies to the “H” to give alignment and a route).

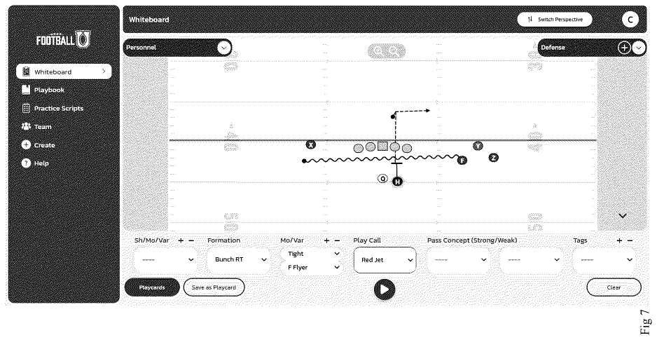

FIG. 8.—Pass concept chosen (applies to the Y and Z based on their alignment in this formation).

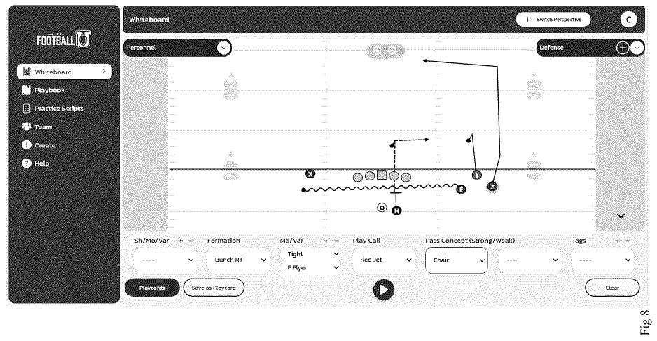

FIG. 9—Tag is chosen (applies to X and gives him a route—“slant”).

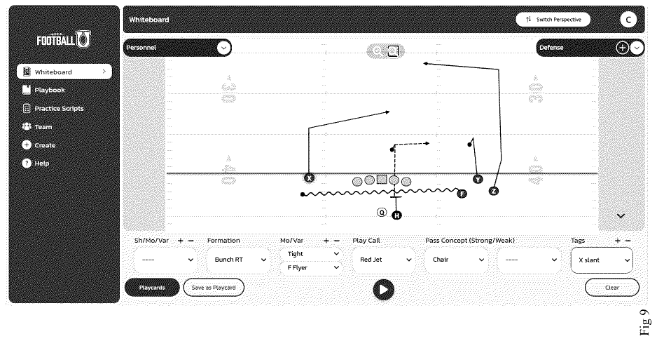

FIG. 10—Second Tag is chosen (applies to “F” and gives him a route—“Comeback”).

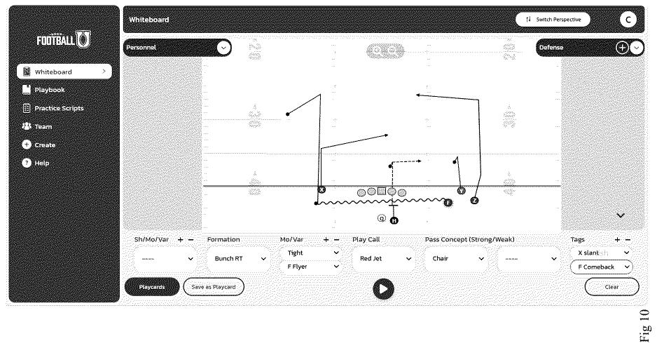

What is claimed:

1. A system for creating and visualizing football plays, comprising:
a syntax-driven play creation module configured to receive user inputs corresponding to predefined components of a football play, including formations, motions, routes, and pass concepts;
a visualization engine configured to dynamically render a 2D graphical representation of a football play based on the received syntax inputs;
a digital whiteboard interface enabling users to input, edit, and organize play components through a structured syntax; and
a mobile application module configured to assign and distribute visualized plays to players for independent review and practice.

2. A method for creating and visualizing football plays, comprising:
receiving user input in the form of a predefined syntax corresponding to components of a football play;
parsing the received syntax to identify specific play elements, including formations, motions, routes, and pass concepts;
rendering a 2D visualization of the football play on a graphical interface based on the parsed syntax; and
providing the visualized play to a mobile application for distribution to individual players for review and practice.

3. A football playbook generation system, comprising:
a modular syntax processing engine configured to separate and organize inputs into distinct football play components;
a rendering engine configured to generate a 2D visual representation of football plays from the organized components;
a play assignment module enabling coaches to distribute visualized plays to designated players via a mobile platform; and
a non-sensor-based architecture configured to operate independently of real-time telemetry or player performance data.

4. The system of claim 1, wherein the syntax-driven play creation module further comprising a predefined sequence-based syntax comprising a structured order of play components, including pre-snap adjustments (shifts or motions), formations, play calls, and optional modifiers (tags, pass concepts); and
a parsing system enforcing a consistent, hierarchical arrangement of these elements to ensure clarity, recall, and compatibility with visual rendering.

5. The method of claim 2, further comprising generating a report summarizing the syntax inputs and corresponding visualized plays for use in team strategy planning.

6. The system of claim 1, wherein the visualization engine includes options to highlight specific player routes and assignments within the rendered play.

7. The system of claim 3, further comprising an interactive replay feature enabling users to step through visualized plays incrementally.

8. The system of claim 1, wherein the digital whiteboard interface allows real-time collaboration between multiple users for simultaneous play creation.

9. The method of claim 2, wherein the mobile application module further includes feedback functionality to allow players to annotate and comment on visualized plays.

10. The system of claim 3, wherein the modular syntax processing engine is configured to validate user input for syntax errors and provide recommendations for corrections.

11. The system of claim 1, wherein the visualization engine is configured to display the 2D graphical representation on multiple platforms, including desktops, tablets, and mobile devices.

12. The method of claim 2, further comprising storing the visualized plays in a cloud-based database for retrieval and reuse.

13. The system of claim 3, further comprising an analytics module to track and display player interaction with the assigned plays within the mobile application.

14. The system of claim 1, wherein the syntax-driven play creation module includes a library of predefined formations and routes for use as building blocks in play creation.

15. The system of claim 3, wherein the play assignment module is configured to group plays into categorized drills for targeted player training.

16. The system of claim 1, wherein the syntax-driven play creation module further defines all player alignments relative to the center, comprising:
a positional reference system where each player's X-coordinate is calculated based on the center's location on the field; and
a flexible alignment logic that adjusts player coordinates dynamically when the center moves between different landmarks (e.g., hashes).

17. A computer-implemented method for creating and visualizing sports plays, comprising:
Receiving, at a computing device, user input to create and display a 2D sports play; the play comprises a plurality of players, formations, motions, and routes defined using a structured syntax; displaying, by the computing device, the 2D sports play in a graphical user interface using syntax-driven inputs associated with the play, formations, and routes; the graphical user interface includes interactive elements representing players, routes, and play attributes;
receiving, through the graphical user interface, user input to modify components of the 2D sports play by selecting and adjusting player positions, routes, or timing elements and typing syntax commands to redefine formations, motions, or pass concepts;
Automatically updating, by the computing device, the visualization of the 2D sports play in real time based on the user input; synchronizing the changes to all affected components within the play, including adjustments to player routes and positional details;
Distributing the updated 2D sports play to a mobile application for review and practice by individual players; the mobile application provides interactive playback, annotations, and personalized feedback for enhanced learning and retention; and
Operating independently of real-time telemetry, motion tracking, or sensor-based inputs, focusing on predefined syntax-driven data and 2D visualizations.
